(19) United States
(12) Patent Application Publication
(10) Pub. No.: US 2005/0152460 A1
(43) Pub. Date: Jul. 14, 2005

(54) Transmitting/receiving system, receiver and transmitter with crosstalk suppressing function

(75) Inventors: Hideo Yoshimi, Tokyo (JP); Kiyoshi Fukuchi, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/029,931

(22) Filed: Jan. 5, 2005

(30) Foreign Application Priority Data
Jan. 9, 2004 (JP) 004801/2004

(51) Int. Cl. H04B 1/69

(52) U.S. Cl. 375/257

(57) ABSTRACT

From a transmitter to a transmission line, a baseband signal is transmitted together with a replica signal created by superposing the baseband signal onto Carrier Frequency C1. Similarly, from a transmitter to a transmission line, a baseband signal is transmitted together with a replica signal created by superposing the baseband signal onto Carrier Frequency C2. At a receiver, the receive signal is branched into two. From one of the branched signals, the baseband signal is extracted by passing the signal through a filter. From the remaining signal, the replica signal on Carrier Frequency C2 is converted into the baseband, which is also extracted. The resultant signals are input to an adaptive equalizer. The output signal from the adaptive equalizer now has the same waveform as the crosstalk signal that has crossed into the baseband signal. The crosstalk can be suppressed by subtracting these two signals from each other by use of a subtracter.

### BACKGROUNDS OF THE INVENTION

1. Field of the Invention

The present invention relates to a transmitting/receiving system, and more particularly, to a transmitting/receiving system and its receiver and transmitter with a crosstalk suppressing function.

2. Description of the Related Art

The type of transmitting/receiving system described in the section above has been used to realize high-quality information transfer in a variety of communication environments, including even those that are exposed to crosstalk from adjacent cables. An example of transmitting/receiving system with a crosstalk suppressing function is disclosed in Japanese Patent Laying-Open (Kokai) No. Heisei 6-152476 Official Gazette (Literature 1) and Japanese Patent Laying-Open (Kokai) No. 2002-507076 Official Gazette (Literature 2).

FIG. 11 shows a typical conventional transmitting/receiving system with a crosstalk suppressing function. As shown in FIG. 11, this system has two transmission lines 131, 132, to which two signal sources 111, 121 are connected respectively. Examples of systems adopting this type of configuration include Ethernet(R) and ADSL/ISDN. In these systems, twist pair cables and coaxial cables are used as transmission media.

When one of the signal sources 111, 121 sends out a signal to its transmission line 131 or 132, part of the signal often crosses into the other transmission line due to their close vicinity to each other. This undesirable phenomenon is referred to as crosstalk. Particularly problematic with this phenomenon is a crosstalk signal that is propagated through the pathway 111b. This crosstalk signal crosses into the pathway of the other signal source near the input point. This means that the signal enters the receiver without receiving any attenuation from the transmission line. This kind of crosstalk is called near end crosstalk, which will hereinafter be referred by its acronym, NEXT.

FIG. 12 shows the frequency spectrum at the input of the transmission line 132 from the signal source 121. FIG. 13 shows the frequency spectrum, where no NEXT is present, at the output of the transmission line 132 from the signal source 121. FIG. 14 shows the frequency spectrum at the input of the transmission line 131 from the signal source 111. FIG. 15 shows the frequency spectrum of NEXT at the output of the transmission line 132 (i.e., the input of the receiver).

A signal sent out from the signal source 121 to the transmission line 132 is attenuated significantly before entering the receiver, due to a large loss caused by the transmission line 132; its frequency spectrum follows a curve as that shown in FIG. 13. As a result, the frequency spectrum of the signal observed at the input of the receiver becomes as shown in FIG. 16, representing a significant deterioration in the signal-to-noise ratio (SNR).

The transmitting/receiving system of the present invention resolves this problem by incorporating a NEXT suppressing device (NEXT canceller).

The configuration of this NEXT suppressing device will first be described in detail by using FIG. 11. The NEXT suppressing device includes a NEXT signal generating device 145 which generates a quasi-NEXT signal 145a from a signal 111a from the signal source 111; a subtracter 146 which subtracts a quasi-NEXT signal 145a from a receive signal 132a; and a coefficient optimizing device 147 which optimizes the coefficient for the NEXT signal generating device 145 based on an output signal 146a from the subtracter 146.

The NEXT signal generating device 145 is provided with a delayer 1451 which delays the signal 111a from the signal source 111; and an equalizer 1452 which generates a quasi-NEXT signal from an output signal 1451a from the delayer 1451.

The coefficient optimizing device 147 has a correlation operator 1471 which computes a correlation between a NEXT-free signal 146a that is output from the subtracter 146 and a signal 1451a that is output from the delayer 1451; and a coefficient adjusting part 1472 which increases or decreases the coefficient for the equalizer 1452 based on a correlation 1471a computed by this correlation operator 1471.

The operation of this NEXT suppressing device will now be described in detail. The transmit signal 111a from the signal source 111 (FIG. 14) is first branched into two. One of the branched signals is sent out to the transmission line 131 and the other is input into the delayer 1451. Part of the signal sent out to the transmission line 131 becomes a NEXT 111b (FIG. 15), which is observed as a component of the receive signal 132a on the elapse of the propagation time “τ”

The delayer 1451 synchronizes the timing between the output signal 1451a and the NEXT signal 111b by delaying the input signal 111a by the time “τ” The output signal 1451a of the delayer 1451 is input into the equalizer 1452. The equalizer 1452 reshapes the input signal 1451a based on the equalizer coefficient so that the output signal 145a and the NEXT signal 111b will have the same waveform. One example of device that is often chosen for use as this equalizer 1452 is a transversal filter.

The output signal 145a from the equalizer 1452 and the receive signal 132a, which is an output of the transmission line 132 from the signal source 121 (FIG. 16), are transmitted to the subtracter 146. Since the signal 145a has been made to have the same waveform as the NEXT signal 111b (FIG. 15), the NEXT component of the signal 132a can be suppressed by subtracting the signal 145a from the receive signal 132a.

In order for the NEXT signal 111b to be suppressed sufficiently, the output signal 145a from the equalizer 1452 must be equal to the NEXT signal 111b. This is achieved by using the coefficient optimizing device 147. First, the correlation operator 1471 is used to compute a correlation between the signal 146a and the signal 1451a. The resultant correlation 1471a corresponds to the amount of NEXT contained in the signal 146a. Therefore, the NEXT signal can be reduced to a sufficiently low level by changing the equalizer coefficient until the correlation becomes as low as desired. For the purpose of use as the above-described correlation computing algorithm, the least mean square (LMS) algorithm is commonly employed to accommodate the complexity of the computation.

In order to remove a NEXT signal that has crossed into a receive signal, a conventional NEXT suppressing device as is described in the foregoing requires the original information concerning the NEXT signal. This means that two communication devices must be physically connected by wiring as shown in FIG. 11. Such wiring is possible only if the two communication devices, i.e., transmitter and receiver, are configured into the same package, as shown in FIG. 17. In contrast, configurations like the one as shown in FIG. 18, where the transmitter and the receiver are located in separate packages, will inevitably present great difficulties in physically connecting between these two different communication devices.

For this reason, it has been impossible to suppress NEXT from a communication device that is not contained in the same package. This kind of NEXT, which crosses in from a communication device outside the package, is called “alien NEXT,” or alien near end cross talk (ANEXT), which will hereinafter be used to refer to such ANEXT. Thus, a system that can suppress ANEXT is awaited in order to realize consistently high-quality transmission of information in communication devices.

### SUMMARY OF THE INVENTION

The present invention, which has been developed to address the above-described problem, aims at providing a transmitting/receiving system and its receiver and transmitter that can suppress ANEXT effectively, without needing to be wire-connected with a nearby transmitter that is the source of the ANEXT signal, by detecting the original information concerning an ANEXT signal that has crossed into its receive signal and then suppressing the ANEXT signal effectively.

According to the first aspect of the invention, a transmitting/receiving system which transmits signals using two or more transmission lines, wherein a transmitter and a receiver on one transmission line suppresses crosstalk in a receive baseband signal by detecting, through use of the high-pass characteristics of crosstalk signals, a crosstalk signal which has been sent out by another transmitter as a source of crosstalk on another transmission line, and which has been superposed onto the baseband signal.

According to the second aspect of the invention, a transmitting/receiving system which transmits signals using two or more transmission lines, wherein a transmitter on each of the transmission lines comprises a transmitting part which transmits baseband signals after superposing a replica signal of each of the baseband signals for transmission onto the baseband signal; and a receiver on the transmission line comprises a filter which extracts the component of the baseband signal received that is inside the baseband, an extracting part which extracts each of the replica signals that causes a crosstalk by crossing in from the baseband signal received, an equalizing part which generates a quasi-crosstalk by equalizing each of the replica signals extracted, and a subtracter which subtracts the quasi-crosstalk signal from the signal inside the baseband.

In the preferred construction, the receiver includes as many the extracting parts and as many the equalizing parts as the number of transmitters on other transmission line, and multiple the extracting parts extract multiple the replica signals which have crossed in from other transmission line.

In another preferred construction, the equalizing part is an adaptive equalizer which is optimized so that the crosstalk component contained in an output signal from the subtracter will be minimized.

In another preferred construction, the receiver includes as many the extracting parts and as many the equalizing parts as the number of transmitters on other transmission line, multiple the extracting parts extract individually multiple the replica signals which have crossed in from other transmission line, and the equalizing part is an adaptive equalizer which is optimized so that the crosstalk component contained in an output signal from the subtracter will be minimized.

In another preferred construction, the replica signal is generated by performing single-sideband frequency modulation or vestigial side-band modulation on the baseband signal.

In another preferred construction, the each replica signal is superposed by multiplexing the replica signal by frequency division into a different frequency area by use of a carrier wave with a frequency over two times wider than the baseband bandwidth.

In another preferred construction, the transmitting part of the transmitter includes an up-converter which multiplexes the replica signal by frequency division into the baseband signal, and the extracting part of the receiver includes a down-converter which separates the replica signal from the baseband signal.

In another preferred construction, the transmitting part of the transmitter includes an up-converter which multiplexes the replica signal by frequency division into the baseband signal, the extracting part of the receiver includes a down-converter which separates the replica signal from the baseband signal, and carrier frequencies of the up-converter which multiplexes the each replica signal by frequency division and of the down-converter which separates the replica signal from the baseband signal are adjustable.

In another preferred construction, the transmitting part of the transmitter includes an up-converter which multiplexes the replica signal by frequency division into the baseband signal, the extracting part of the receiver includes a down-converter which separates the replica signal from the baseband signal, carrier frequencies of the up-converter which multiplexes the each replica signal by frequency division and of the down-converter which separates the replica signal from the baseband signal are adjustable, and output signal strength at the output of the down-converter is first measured while sweeping the carrier frequencies of the down-converter, and then the down-converter is assigned a carrier frequency at which the signal strength reaches the maximum and the up-converter is assigned a carrier frequency which will not interfere with such carrier frequency.

In another preferred construction, the each replica signal is superposed through code-division multiplexing by use of spectrum spreading code sequences which are in an orthogonal relationship with each other.

In another preferred construction, the replica signal is spread from the baseband signal across the spectrum and superposed onto the baseband signal in such a manner that the frequency spectrums of the replica signal and the baseband signal will not overlap with each other.

In another preferred construction, the transmitting part of the transmitter includes a spectrum spreader which spreads the baseband signal across the spectrum and which superposes the resultant signal onto the baseband signal in such a manner that the frequency spectrums of the replica signal and the baseband signal will not overlap with each other, and the extracting part of the receiver includes a spectrum reverse spreader which restores the superposed replica signal component.

In another preferred construction, code sequences of the spectrum spreader and of the spectrum reverse spreader are adjustable.

In another preferred construction, code sequences of the spectrum spreader and of the spectrum reverse spreader are adjustable, and output signal strength at the output of the spectrum reverse spreader is first measured while varying code sequences of the spectrum reverse spreader, and then the spectrum reverse spreader is assigned a code sequence at which the signal strength reaches the maximum and the spectrum spreader is assigned a code sequence which is in an orthogonal relationship with the code sequence assigned to the spectrum reverse spreader.

According to another aspect of the invention, a receiver on a transmitting/receiving system which transmits signals using two or more transmission lines, comprising:
receiving from the transmitter of each transmission line a signal created by superposing a replica signal onto the baseband signal, and including a filter which extracts the component of the baseband signal received that is inside the baseband, an extracting part which extracts each of the replica signals that causes a crosstalk by crossing in from the baseband signal received, an equalizing part which generates a quasi-crosstalk by equalizing each of the replica signals extracted, and a subtracter which subtracts the quasi-crosstalk signal from the signal inside the baseband.

In the preferred construction, The receiver, wherein as many the extracting parts and as many the equalizing parts as the number of transmitters on other transmission line are included, and multiple the extracting parts extract individually multiple the replica signals which have crossed in from other transmission line.

In another preferred construction, the equalizing part is an adaptive equalizer which is optimized so that the crosstalk component contained in an output signal from the subtracter will be minimized.

In another preferred construction, the each replica signal is superposed by multiplexing the replica signal by frequency division into a different frequency area by use of a carrier wave with a frequency over two times wider than the baseband bandwidth.

In another preferred construction, the extracting part of the receiver includes a down-converter which separates the replica signal from the baseband signal, with respect to the signal which has been transmitted after being multiplexed into the baseband signal by frequency division through use of the up-converter of the transmitter.

In another preferred construction, the extracting part of the receiver includes a down-converter which separates the replica signal from the baseband signal, with respect to the signal which has been transmitted after being multiplexed into the baseband signal by frequency division through use of the up-converter of the transmitter, and carrier frequency of the down-converter which separates the replica signal from the baseband signal is adjustable.

In another preferred construction, the extracting part of the receiver includes a down-converter which separates the replica signal from the baseband signal, with respect to the signal which has been transmitted after being multiplexed into the baseband signal by frequency division through use of the up-converter of the transmitter, carrier frequency of the down-converter which separates the replica signal from the baseband signal is adjustable, and output signal strength at the output of the down-converter is first measured while sweeping the carrier frequencies of the down-converter, and then the down-converter is assigned a carrier frequency at which the output signal strength reaches the maximum and the up-converter is assigned a carrier frequency which will not interfere with such carrier frequency.

In another preferred construction, the each replica signal is superposed through code-division multiplexing by use of spectrum spreading code sequences which are in an orthogonal relationship with each other.

In another preferred construction, the each replica signal is superposed through code-division multiplexing by use of spectrum spreading code sequences which are in an orthogonal relationship with each other, and the extracting part of the receiver includes a spectrum reverse spreader which restores the superposed replica signal component from the signal created by spreading the baseband signal across the spectrum by use of the spectrum spreader of the transmitter and then superposing the resultant signal so that the frequency spectrum of the resultant signal will not overlap with the frequency spectrum of the baseband signal.

In another preferred construction, the receiver, wherein code sequences of the spectrum spreader and of the spectrum reverse spreader are adjustable.

In another preferred construction, the receiver, wherein code sequences of the spectrum spreader and of the spectrum reverse spreader are adjustable, and output signal strength at the output of the spectrum reverse spreader is first measured while varying code sequences of the spectrum reverse spreader, and then the spectrum reverse spreader is assigned a code sequence at which the signal strength reaches the maximum and the spectrum spreader is assigned a code sequence which is in an orthogonal relationship with the code sequence assigned to the spectrum reverse spreader.

According to another aspect of the invention, a transmitter on a transmitting/receiving system which transmits signals using two or more transmission lines, comprises a transmitting part which transmits baseband signals after superposing a replica signal of each of the baseband signals for transmission onto the baseband signal.

In the preferred construction, the replica signal is generated by performing single-sideband frequency modulation or vestigial side-band modulation on the baseband signal.

In another preferred construction, the each replica signal is superposed by multiplexing the replica signal by frequency division into a different frequency area by use of a carrier wave with a frequency over two times wider than the baseband bandwidth.

In another preferred construction, the transmitting part of the transmitter includes an up-converter which multiplexes the replica signal by frequency division into the baseband signal, and the replica signal is separated from the baseband signal by the down-converter of the receiver.

In another preferred construction, the transmitting part of the transmitter includes an up-converter which multiplexes the replica signal by frequency division into the baseband signal, the replica signal is separated from the baseband signal by the down-converter of the receiver, and the carrier frequency of the up-converter which multiplexes the each replica signal by frequency division is adjustable along with the carrier frequency of the down-converter of the receiver which separates the replica signal from the baseband signal.

In another preferred construction, the transmitting part of the transmitter includes an up-converter which multiplexes the replica signal by frequency division into the baseband signal, the replica signal is separated from the baseband signal by the down-converter of the receiver, the carrier frequency of the up-converter which multiplexes the each replica signal by frequency division is adjustable along with the carrier frequency of the down-converter of the receiver which separates the replica signal from the baseband signal, and the up-converter is assigned a carrier frequency which will not interfere with the carrier frequency assigned to the down-converter.

In another preferred construction, the each replica signal is superposed through code-division multiplexing by use of spectrum spreading code sequences which are in an orthogonal relationship with each other.

In another preferred construction, the replica signal is spread from the baseband signal across the spectrum and superposed onto the baseband signal in such a manner that the frequency spectrums of the replica signal and the baseband signal will not overlap with each other.

In another preferred construction, the each replica signal is superposed through code-division multiplexing by use of spectrum spreading code sequences which are in an orthogonal relationship with each other, and the transmitting part of the transmitter includes a spectrum spreader which spreads the baseband signal across the spectrum and which superposes the resultant signal onto the baseband signal in such a manner that the frequency spectrums of the replica signal and the baseband signal will not overlap with each other.

In another preferred construction, the each replica signal is superposed through code-division multiplexing by use of spectrum spreading code sequences which are in an orthogonal relationship with each other, and code sequence of a spectrum spreader is adjustable along with the code sequence of a spectrum reverse spreader of a receiver.

In another preferred construction, the each replica signal is superposed through code-division multiplexing by use of spectrum spreading code sequences which are in an orthogonal relationship with each other, code sequence of a spectrum spreader is adjustable along with the code sequence of a spectrum reverse spreader of a receiver, and output signal strength at the output of the spectrum reverse spreader is first measured while varying code sequences of the spectrum reverse spreader, and then the spectrum reverse spreader is assigned a code sequence at which the output signal strength reaches the maximum and the spectrum spreader is assigned a code sequence which is in an orthogonal relationship with the code sequence assigned to the spectrum reverse spreader.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the configuration of a transmitting/receiving system with a crosstalk suppressing function according to the first embodiment of the present invention;

FIG. 2 is a block diagram showing the configuration of a transmitting/receiving system with a crosstalk suppressing function according to the fourth embodiment of the present invention;

FIG. 3 is a block diagram showing the detailed configuration of the transmitting/receiving system with a crosstalk suppressing function according to the first embodiment of the present invention;

FIG. 4 is a block diagram showing the configuration of a transmitting/receiving system according to the second embodiment of the present invention to specifically deal with cases where more than one ANEXT signal source are present;

FIG. 5 is a block diagram showing the configuration of a transmitting/receiving system according to the third embodiment of the present invention to specifically deal with cases where more than one ANEXT signal source are present;

FIG. 6 is a block diagram showing the detailed configuration of the transmitting/receiving system with a crosstalk suppressing function according to the fourth embodiment of the present invention;

FIG. 7 is a block diagram showing the detailed configuration of a transmitting/receiving system with a crosstalk suppressing function according to the fifth embodiment of the present invention;

FIG. 8 is a block diagram showing the detailed configuration of a transmitting/receiving system with a crosstalk suppressing function according to the sixth embodiment of the present invention;

FIG. 9 is a block diagram showing the detailed configuration of a transmitting/receiving system with a crosstalk suppressing function according to the seventh embodiment of the present invention;

FIG. 10 is a block diagram showing the detailed configuration of a transmitting/receiving system with a crosstalk suppressing function according to the eighth embodiment of the present invention;

FIG. 11 is a block diagram showing the configuration of a conventional transmitting/receiving system with a crosstalk suppressing function.

FIG. 12 is a diagram showing the frequency spectrum, where no NEXT is present, in the output of the transmission line 132 from the signal source 121 of the transmitting/receiving system of FIG. 11;

FIG. 13 is a diagram showing the frequency spectrum, where no NEXT is present, at the output of the transmission line 132 from the signal source 121 of the transmitting/receiving system of FIG. 11;

FIG. 14 is a diagram showing the frequency spectrum at the input of the transmission line 131 from the signal source 111 of the transmitting/receiving system of FIG. 11;

FIG. 15 is a diagram showing the frequency spectrum of NEXT at the output (input of the receiver) of the transmission line 132 of the transmitting/receiving system of FIG. 11;

FIG. 16 is a diagram showing the frequency spectrum of a signal being observed at the input of the receiver of the transmitting/receiving system of FIG. 11;

FIG. 17 is a diagram showing a case where a conventional crosstalk suppressing device can be applied; and

FIG. 18 is a diagram showing a case where a conventional crosstalk suppressing device cannot be applied.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

The embodiments of the present invention will now be described in detail with reference to the drawings.

### First Embodiment

The transmitting/receiving system with a crosstalk suppressing function according to the first embodiment of the present invention is provided on its transmitter side with a part which transmits baseband signals via each of its transmission lines after superposing a replica signal of each of the baseband signals onto a band outside the baseband; and includes on its receiver side a filter which separates the component inside the baseband at the output of its transmission line; a part which extracts the replica signal component, which has been superposed onto a nearby transmission line, from the component outside the baseband and convert the extracted replica signal into the baseband; an equalizer which generates a quasi-ANEXT signal from the converted replica signal; and a subtracter which subtracts the quasi-ANEXT signal from the signal inside the baseband.

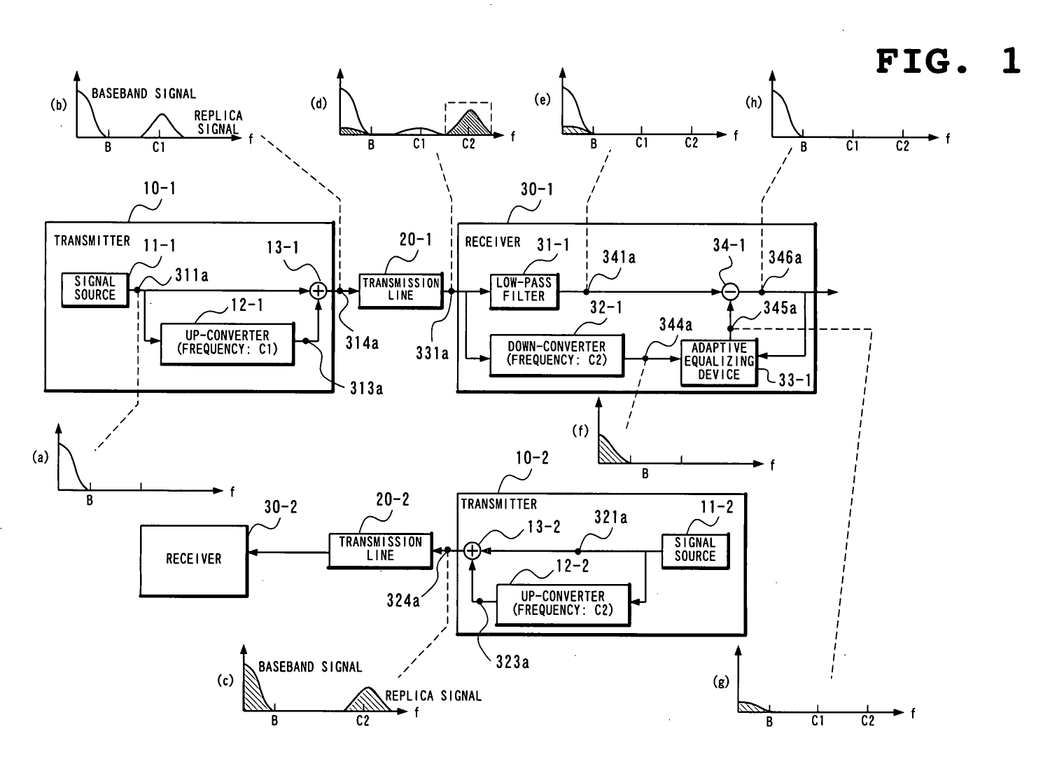

FIG. 1 shows the configuration of the transmitting/receiving system with a crosstalk suppressing function according to the first embodiment of the present invention.

The transmitter 10-1 superposes a replica signal 313a obtained from the up-converter 12-1 onto a bandwidth outside the bandwidth of the baseband signal 311a from the signal source 11-1 by using the adder 13-1, and sends out the superposed signal to the transmission line 20-1. In FIG. 1, (a) shows the baseband signal and (b) the signal spectrum of the signal onto which the replica signal has been superposed. The signal spectrum sent out from the transmitter 10-2 to the transmission line 20-2 is shown in (c) in FIG. 1.

The spectrum of the signal received by the receiver 30-1 becomes as shown by (d) because it consists of not only the signal from the transmitter 10-1 but also ANEXT that has crossed into the receive signal from the transmitter 10-2.

The receiver 30-1 separates the component of the receive signal in the baseband at the output of the transmission line 20-1 by using the filter 31-1 (FIG. 1(e)) and extracts the replica signal getting into the transmission line, indicated by a dotted line (d), by use of the down-converter 32-1 to suppress the ANEXT component that has crossed into the baseband. As a result of this process, the replica signal as indicated by (f) in FIG. 1 is extracted.

The extracted replica signal (f) is then made to pass the adaptive equalizing device 33-1 to generate a waveform equivalent to that of the ANEXT component that has crossed into the baseband (FIG. 1(g)). Finally, by subtracting this equalized signal (FIG. 1(g)) from the baseband signal (FIG. 1(e)), the ANEXT component that has crossed into the baseband can be suppressed effectively (FIG. 1(h)).

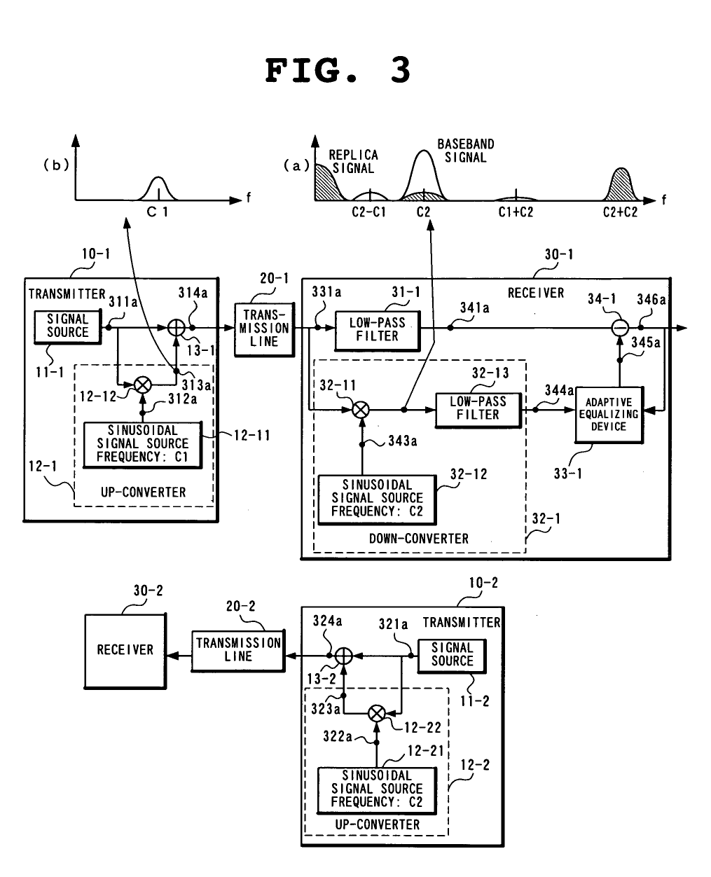

FIG. 3 shows the more detailed configuration of the transmitting/receiving system with a crosstalk suppressing function according to the first embodiment of the present invention, wherein this system includes transmitters 10-1, 10-2 which generate and output transmit signals; transmission lines 20-1, 20-2 which are twist pair transmission lines; and receivers 30-1, 30-2 which incorporate an ANEXT suppressing function.

The transmitter 10-1 further comprises a signal source 11-1 which outputs a baseband signal 311a in Bandwidth B; an up-converter 12-1 consisting of a sinusoidal signal source 12-11 which outputs a sinusoidal wave of Frequency C1 and a multiplier 12-12 which multiplies a baseband signal 311a and a sinusoidal signal 312a together to generate a replica signal 313a outside the baseband; and an adder 13-1 which generates a composite signal 314a by adding the baseband signal 311a and the replica signal 313a together.

The transmitter 10-2 further comprises a signal source 11-2 which outputs a baseband signal 321a in Bandwidth B; an up-converter 12-2 consisting of a sinusoidal signal source 12-21 which outputs a sinusoidal wave for Frequency C2 and a multiplier 12-22 which multiplies a baseband signal 321a and a sinusoidal signal 322a together to generate a replica signal 323a outside the baseband; and an adder 13-2 which generates a composite signal 324a by adding the baseband signal 321a and the replica signal 323a together.

The receiver 30-1 comprises a low-pass filter 31-1 which cuts out the part of the baseband signal below Frequency B; a down-converter 32-1 consisting of a sinusoidal signal source 32-12 of Frequency C2; a multiplier 32-11 which down-converts the replica signal leaking in as ANEXT into the baseband; and a low-pass filter 32-13 which cuts out the down-converted replica signal; an adaptive equalizing device 33-1 which generates a quasi-ANEXT signal 345a; and a subtracter 34-1 which subtracts the quasi-ANEXT signal 345a from the baseband signal 341a.

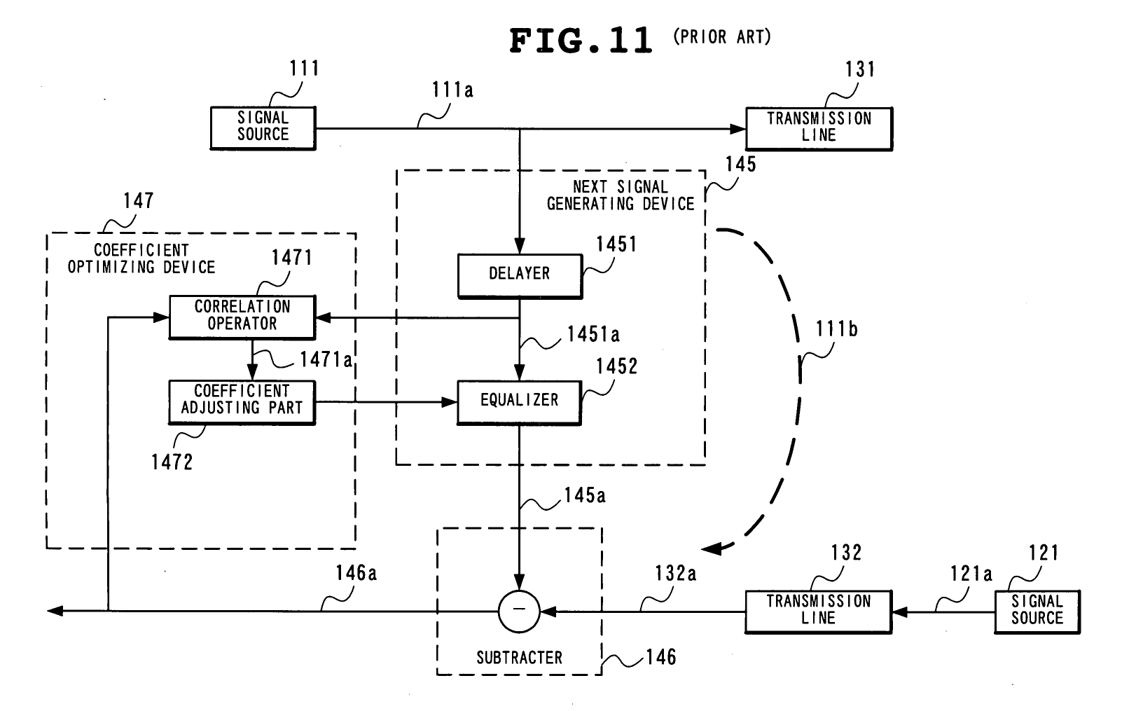

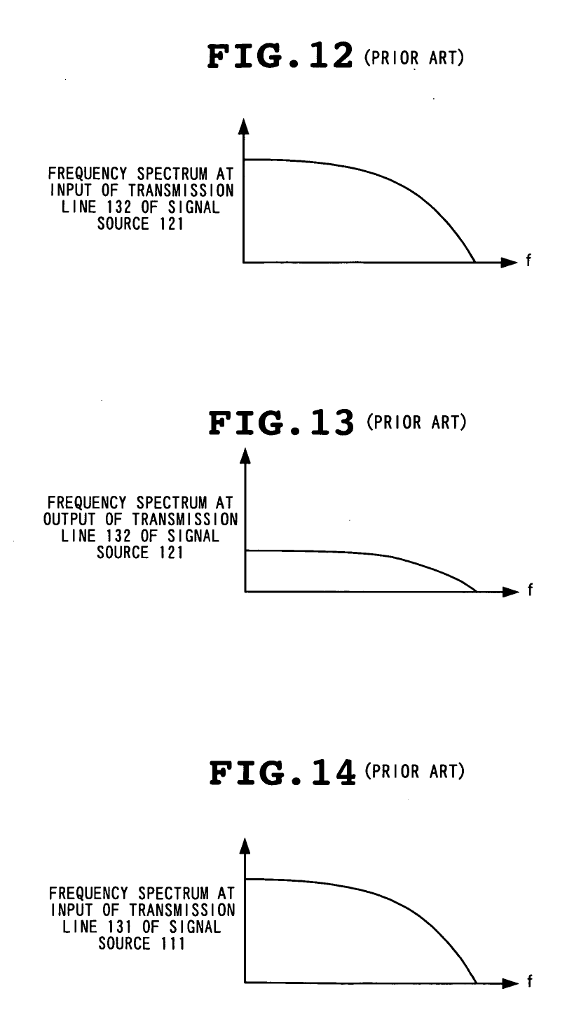

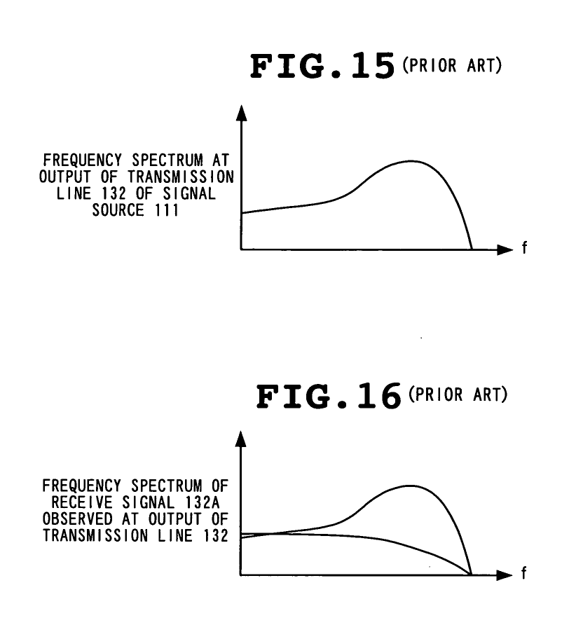

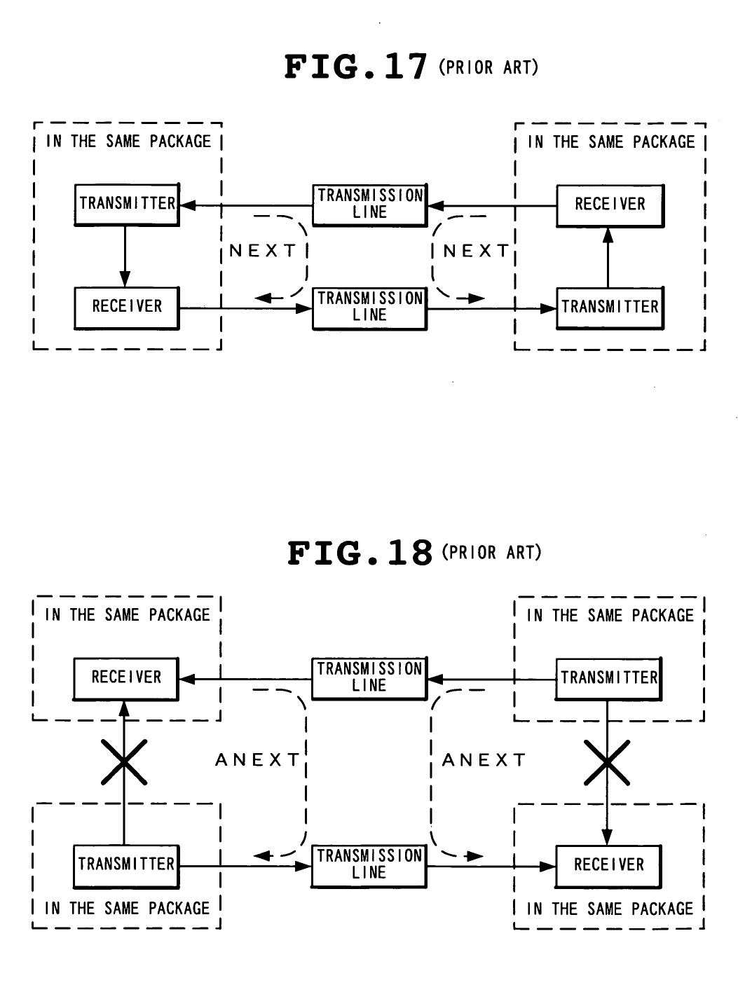

The adaptive equalizing device 33-1 can be made up with, for example, the NEXT signal generating device and the coefficient optimizing device as shown in FIG. 11.

The operation of the first embodiment of the present invention will now be described in detail with reference to FIG. 3.

The baseband signal 311a in Bandwidth B that has been output from the signal source 11-1 is branched into two (FIG. 1(a)). One of the branched signals is multiplied together with the sinusoidal wave 312a of Frequency C1 that has been output from the sinusoidal signal source 12-11 of the up-converter 12-1, and is superposed as the replica signal 313a onto outside the baseband of the baseband signal 311a. The value of Frequency C1 is larger than two times the signal band (i.e., 2B). The other branched signal is added together with the replica signal 313a by the adder 13-1 and is sent out to the transmission line 20-1. The frequency spectrum of the signal 314a, which has been output by the adder 13-1, is as shown in FIG. 1(b).

Similarly, a baseband signal of Bandwidth B is output from the signal source 11-2 of the transmitter 10-2 and is branched into two. One of the branched signals is multiplied together with the sinusoidal wave 322a of Frequency C2 that has been output from the sinusoidal signal source 12-21 of the up-converter 12-2, and is superposed as the replica signal 323a onto outside the baseband of the baseband signal 321a. Frequency C2 is set to such a value that will not allow the frequency spectrum of the replica signal 313a and that of the replica signal 323a to overlap with each other. The other branched signal is added together with the replica signal 323a by the adder 13-2 and is sent out to the transmission line 20-2. The frequency spectrum of the signal 324a, which has been output by the adder 13-2, is as shown in FIG. 1(c).

Since the transmission line 20-1 and the transmission line 20-2 are in close vicinity to each other, the part of the signal 324a that is being propagated along the transmission line 20-2 may very often leak into the transmission line 20-1, thereby causing an ANEXT problem. FIG. 1(d) shows the frequency spectrum of the output signal 331a in the transmission line 20-1. In FIG. 1(d), the baseband signals 311a, 321a are present in the baseband and the replica signals 313a, 323a are present outside this baseband. While the signals in the baseband overlap with each other, the replica signals outside the baseband are separate from each other on the frequency axis.

The transmission lines 20-1, 20-2, which are twist pair transmission lines, show low-pass characteristics and therefore suffer larger attenuation as the frequency becomes higher. On the other hand, since ANEXT from the transmission line 20-2 into the transmission line 20-1 shows high-pass characteristics, its amount increases as the frequency becomes higher. More specifically, if the frequency increases to ten times the original, the amount of ANEXT becomes approx. 30 times larger.

Because of this increase, as shown in FIG. 1(d), the replica signal 323a grows to a signal strength sufficient for accurate measurement by when it crosses into the transmission line, even though it is in the high-frequency area. A transmitting/receiving system with an ANEXT suppressing function according to the present invention can suppress an ANEXT signal that has crossed into the baseband by utilizing this replica signal 323a as the original information concerning the ANEXT signal. The operation of a receiver with the above-described ANEXT suppressing function will be described below.

The receiver 30-1 first branches a receive signal 331a into two. It then passes one of the branched signals through the low-pass filter 31-1 to extract a baseband signal (FIG. 1(e)). The remaining branched signal is multiplied together with a sinusoidal wave of Frequency C2 that has been output from the sinusoidal signal source 32-12 of the down-converter 32-1, and thereby the replica signal crossing from the transmission line 20-2 is down-converted to the baseband. This branched signal is passed through the low-pass filter 32-13 of the down-converter 32-1 to extract the replica signal only.

The output signal from the low-pass filter 32-13 is input to the adaptive equalizing device 33-1. The adaptive equalizing device 33-1 reshapes the input signal 344a (FIG. 1(f)) so that the output signal 345a (FIG. 1(g)) and the ANEXT signal that has crossed into the baseband signal 341a (FIG. 1(e)) have the same waveform. In other words, a quasi-ANEXT signal (output signal 345a) is generated and output from the adaptive equalizing device 33-1.

The output signal 345a and the baseband signal 341a from the adaptive equalizing device 33-1 are sent to the subtracter 34-1. The signal 345a now has a waveform identical to that of the ANEXT component. The ANEXT component that has crossed into the baseband signal 341a can thus be removed by subtracting the ANEXT component from the signal 345a using the subtracter 34-1 (FIG. 1(h)).

For the purpose of the first embodiment, the replica signal can be anything, as far as it is a modulated component of the original signal at a frequency that does not overlap that of the baseband signal. Thus, the replica signal may be generated not only by double side-band modulation based on multiplication but also by single side-band modulation or vestigial side-band modulation.

The first embodiment is also provided with an adaptive equalizing device (adaptive equalizer) 33-1 to allow the system to accommodate fluctuations in ANEXT caused by changes in the external environment. The filter coefficient for this adaptive equalizer is optimized to minimize the amount of ANEXT remaining in the output signal from the subtracter 34-1. The method of optimizing the adaptive equalizer and other details can be realized by applying the methods disclosed in Literatures 1 and 2 and those described in “Digital Communication” by John Proakis, translation published by Kagaku-Gijutu Shuppan, first edition Nov. 25, 1995, pp. 737-788 (Literature 3), and other works.

### Second Embodiment

While the first embodiment described above caters to situations where there is only one source of ANEXT signals, there is no limit in the number of such sources that can be handled by the present invention. The second embodiment will now be described to explain how the present invention addresses cases where more than one ANEXT signal source is present.

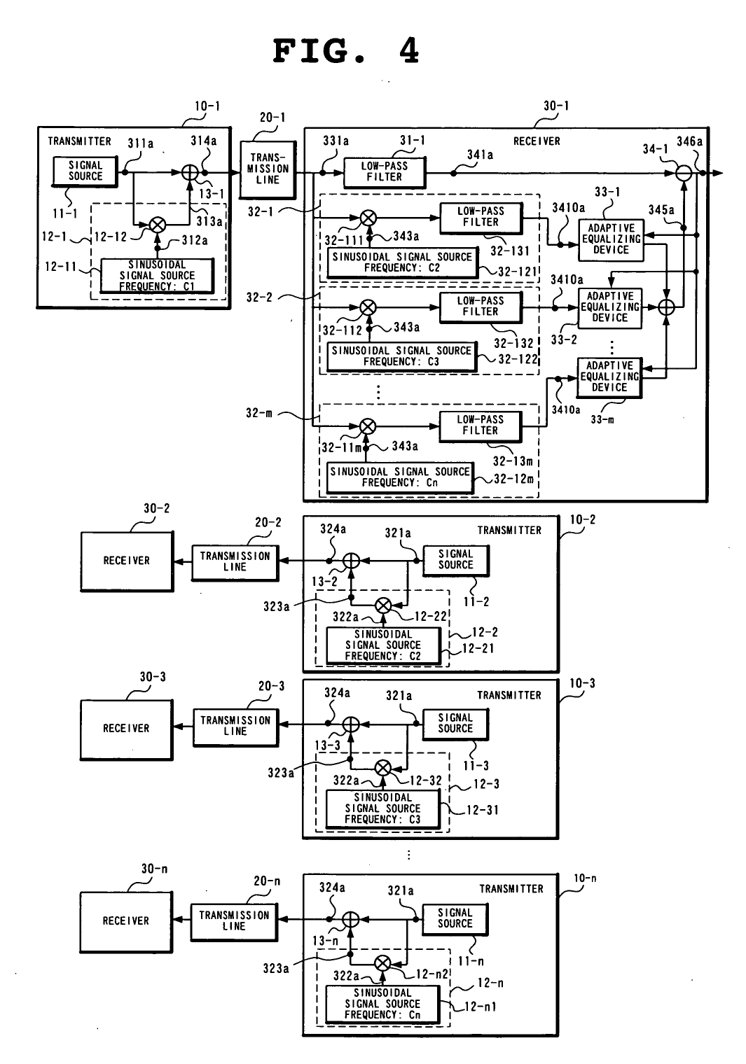

The second embodiment, which addresses more than one ANEXT signal source is present, may be configured as shown in FIG. 4. The configuration shown in FIG. 4 differs from that shown in FIG. 3 in that the system includes the n-1 (where n is an integer 3 or larger) number of ANEXT signal source and transmitters 10-2 to 10-n and that its receiver 30-1 includes the n-1 number of down-converters 32-1 to 32-m (m=n-1) and the n-1 number of adaptive equalizers 33-1 to 33-m. It is also different from the configuration of FIG. 3 in that the adaptive equalizers 33-1 to 33-m are capable of equalizing and reshaping the n-1 number of replica signals extracted from the down-converters 32-1 to 32-m individually. The other components of this configuration are the same as FIG. 3 and therefore will be omitted from the explanation.

The receiver 30-1 first uses the down-converters 32-1 to 32-m to extract the n-1 number of replica signals crossing in from the transmitters 10-2 to 10-n, each of which is an ANEXT signal source. It then inputs each of the extracted replica signals 3410a to the respective adaptive equalizers 33-1 to 33-m.

Each of the adaptive equalizers 33-1 to 33-m reshapes the replica signal 3410a so that the output signal 345a and the ANEXT component that has crossed into the baseband signal 341a have the same waveform. Each of the signals 345a now has a waveform identical to that of the ANEXT component. The ANEXT component that has crossed into the baseband signal 341a can thus be removed by subtracting the ANEXT component from the signal 345a using the subtracter 34-1.

As described above, the first and the second embodiments use the frequency-division multiplex technique to set up the system so that, when superposing replica signals onto outside the baseband, replica signals from other transmission lines will not overlap those of own transmission line. By this, these embodiments can extract the original information of the ANEXT component from the replica signal that has leaked into a band outside the baseband, and use the information to suppress the ANEXT component that has crossed into the bandwidth.

### Third Embodiment

The third embodiment of the present invention will now be described in detail.

Note that, in the first and the second embodiments, the system is set up by assuming that a replica signal getting into the receiver has a known carrier frequency. However, the transmitting/receiving system may possibly be placed in a completely new environment as a result of, for example, rearrangement of the communication devices or introduction of a new communication device. If this happens, the carrier frequency of a replica signal causing a crosstalk is likely to be unknown, preventing the system to suppress ANEXT effectively.

The third embodiment of the present invention, an improvement over the first, is configured to enable the system to detect the carrier frequency of a replica signal getting into the receiver and then to set up the up-converter and the down-converter optimally based on the detected carrier frequency. During the setup process, the system first sets the frequency of the up-converter 12-1 of the transmitter 10-1 in FIG. 5 to “0” and then measures the strength of the output signal from the down-converter 32-1 to be set up by sweeping its frequency. Since the frequency measured when the strength of this output signal reaches the maximum value corresponds to the carrier frequency of the replica signal from the transmitter 10-2, the system assigns this frequency to the down-converter 32-1. At the same time, to the up-converter 12-1, the system assigns a frequency that is different from the frequency of the down-converter, so that frequency interference will not occur between replica signals. By conducting this setup process, it becomes possible for the system to suppress ANEXT under any possible circumstances.

The third embodiment is configured as shown in FIG. 5 to enable the system to detect the carrier frequency of any replica signal in any environment new to the system. The configuration of the third embodiment is different from that of FIG. 4 in that the oscillatory frequency of the sinusoidal signal source 12-11 of the transmitter 10-1 and those of the n-1 number of sinusoidal signal sources 32-121 to 32-12m of the receiver 30-1 are designed to be adjustable (variable).

It is also different from the configuration of FIG. 4 in that the system includes a frequency assigning device 35-1 which sets up optimally the oscillatory frequency of the sinusoidal signal source 12-11 of the transmitter 10-1 and those of the sinusoidal signal sources 32-121 to 32-12m of the receiver 30-1. The other components of this configuration are the same as FIG. 4 and therefore will be omitted from the explanation.

The following explanation assumes that new communication devices, i.e., a transmitter 10-1 and a receiver 30-1, are introduced into a communication environment that already contains transmitters 10-2 to 10-n and receivers 30-2 to 30-n. Using this environment, the operation of the system to set up the carrier frequencies of replica signals in the new transmitter 10-1 and the new receiver 30-1 will now be described.

In the training mode for initialization, the frequency assigning device 35-1 first sets the output signal from the sinusoidal signal source 12-11 of the transmitter 10-1 to “0.” It then sweeps the oscillatory frequency of the sinusoidal signal source 32-121 of the down-converter 32-1 to measure the strength of the output signal that passes the low-pass filter 32-131 and also measures the oscillatory frequency when the strength of the output signal reaches the maximum value. Since the oscillatory frequency measured when the strength of this output signal reaches the maximum value corresponds to Oscillatory Frequency C2 of the sinusoidal signal source 12-21 of the transmitter 10-2, which is the ANEXT signal source, the system assigns this oscillatory frequency to the sinusoidal signal source 32-121.

By repeating the similar setup process, the system sweeps the respective oscillatory frequencies of the sinusoidal signal sources 32-122 to 32-12m of the down-converters 32-2 to 32-m to measure and identify the respective oscillatory frequencies at which the strength of the output signal that passes the low-pass filter 32-132 to 31-13m reaches the maximum value, and assigns these oscillatory frequencies corresponding to the Oscillatory Frequencies C3, . . . Cn of the sinusoidal signal sources 12-31 to 12-n1 of the transmitters 10-3 to 10n, which are the ANEXT signal sources, to the sinusoidal signal sources 32-122 to 32-12m.

At the same time, to the sinusoidal signal source 12-11 of the transmitter 10-1, the system assigns a different frequency that is different from the frequency of the sinusoidal signal sources 32-121 to 32-12m, so that frequency interference will not occur between replica signals.

By designing the sinusoidal signal sources to be adjustable in oscillatory frequency, the third embodiment enables the system to detect and set replica signals getting in the receiver under any possible circumstance. By this, this embodiment can extract the original information of the ANEXT component from the replica signal that is present outside the baseband, and use the information to suppress the ANEXT component that has crossed into the bandwidth, even if the system is installed in a completely new communication environment.

### Fourth Embodiment

The fourth embodiment of the present invention will now be described in detail with reference to the drawings.

The transmitting/receiving system with a crosstalk suppressing function according to the fourth embodiment of the present invention is provided on its transmitter side with a part which transmits each of the baseband signals via each of its transmission lines after superposing each of the replica signals that have been generated by spectrum-spreading each of these baseband signals; and includes on its receiver side a filter which, at the output of its transmission line, separates the component of the signal inside the baseband from the remaining component; a part which restores the superposed spectrum-spread replica signals in a nearby transmission line; an equalizer which generates quasi-ANEXT signals from the restored replica signals; and a subtracter which subtracts the quasi-ANEXT signal from the signal inside the baseband.

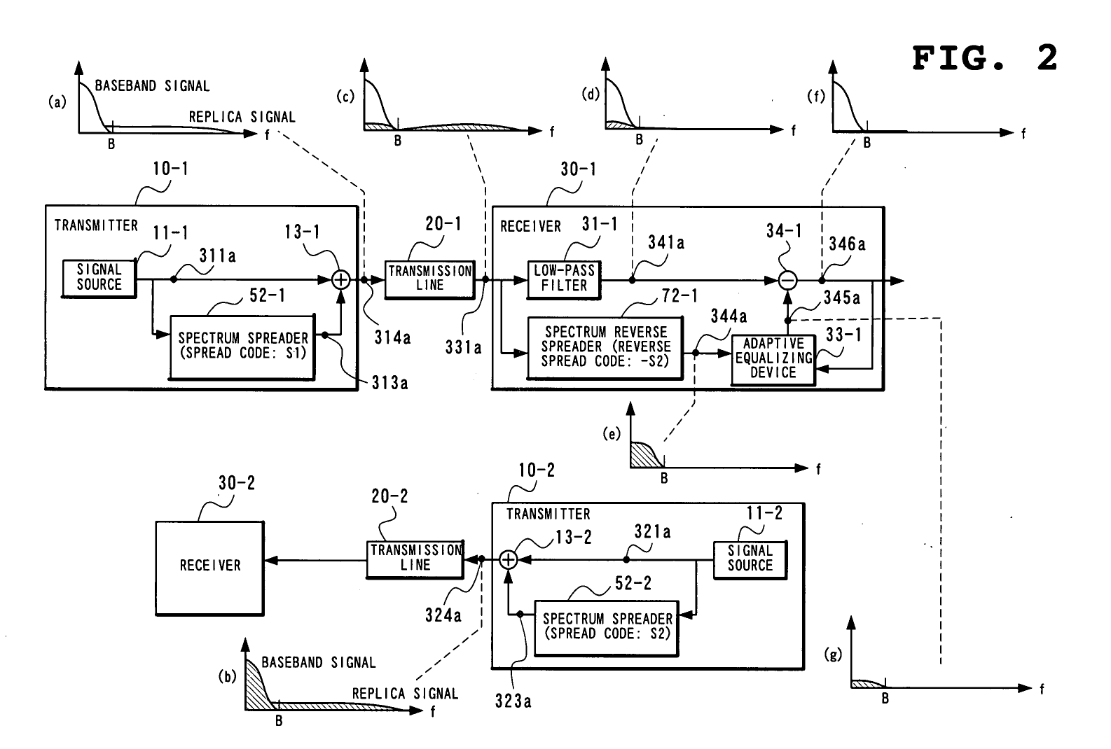

FIG. 2 shows the configuration and operation of the transmitting/receiving system with a crosstalk suppressing function according to the fourth embodiment of the present invention.

The transmitters 10-1, 10-2 send out the signals resultant from superposing the replica signals that have been spectrum-spread by the spectrum spreaders 52-1, 52-2 onto the baseband signals 311a, 321a from the signal sources 11-1, 11-2, to the transmission lines 20-1, 20-2 respectively. FIGS. 2(a) and (b) show each of the signal spectrums, respectively.

The spectrum of the signal received by the receiver 30-1 becomes as shown by FIG. 2(c) because it consists of not only the signal from the transmitter 10-1 but also an ANEXT signal that has crossed into the receive signal from the transmitter 10-2. The receiver 30-1 first restores a replica signal getting into itself by using the spectrum reverse spreader 72-1 to multiply the receive signal by the spectrum reverse spreading code (FIG. 2(e)).

The restored replica signal is then made to pass the adaptive equalizer 33-1 to generate a waveform equivalent to that of the ANEXT component that has crossed into the baseband (FIG. 2(g)). Finally, by subtracting this equalized signal from the baseband signal indicated by (d) in FIG. 2, the ANEXT component that has crossed into the baseband can be suppressed effectively (FIG. 2(f)).

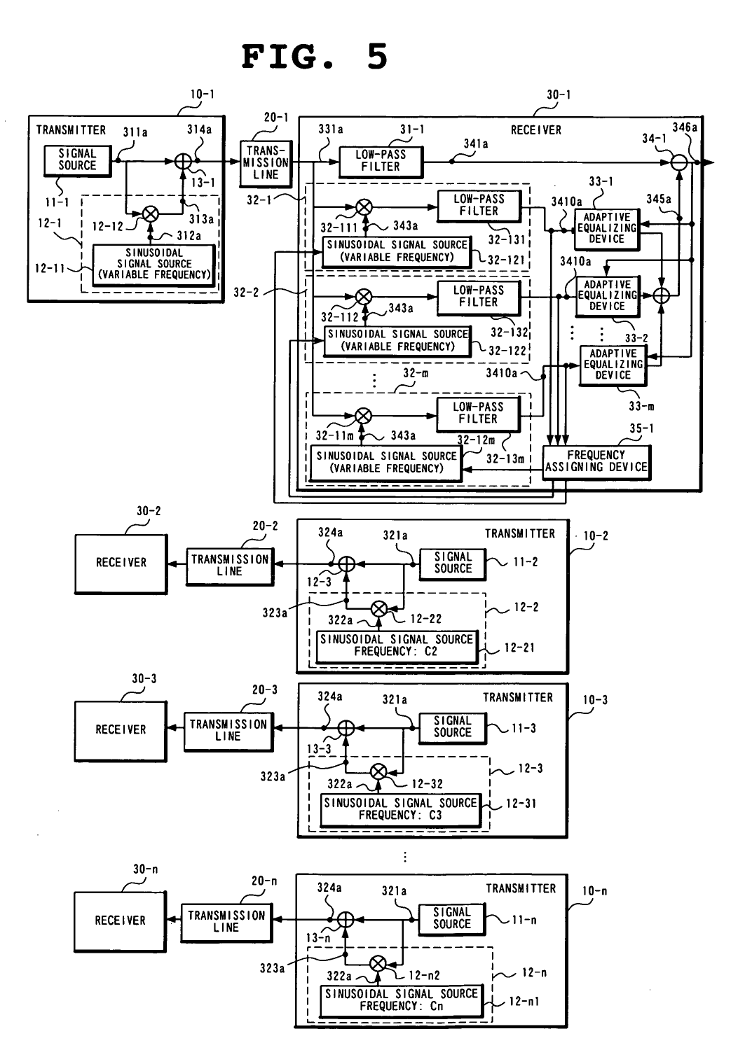

FIG. 6 shows the more detailed configuration of the transmitting/receiving system with a crosstalk suppressing function according to the fourth embodiment of the present invention. This configuration is similar to that of the first embodiment in that the system includes transmitters 10-1, 10-2 which generate and output transmit signals; transmission lines 20-1, 20-2 which are twist pair transmission lines; and receivers 30-1, 30-2 which incorporate an ANEXT suppressing function.

The transmitter 10-1 has a signal source 11-1 which outputs a baseband signal 311a in Bandwidth B; a spectrum spreader 52-1 which consists of a spreading code generator 52-11 and a multiplier 12-12; and an adder 13-1.

The transmitter 10-2 has a signal source 11-2 which outputs a baseband signal 321a in Bandwidth B; a spectrum spreader 52-2 which consists of a spreading code generator 52-21 and a multiplier 12-22; and an adder 13-2.

The receiver 30-1 comprises a low-pass filter 31-1 which cuts out the part of the baseband signal that is below Frequency B; a spectrum reverse spreader 72-1 which consists of a reverse spreading code generator 72-12, a multiplier 32-11 and a low-pass filter 32-13; an adaptive equalizer 33-1 which generates a quasi-ANEXT signal 345a; and a subtracter 34-1 which subtracts the quasi-ANEXT signal 345a from the baseband signal 341a.

With reference to FIG. 6, the fourth embodiment of the present invention is different from the first embodiment shown in FIG. 3 in that its transmitter 10-1 has spreading code generators 52-11, instead of the sinusoidal signal sources 12-11 in the first embodiment. It is also different from the first embodiment shown in FIG. 3 in that the sinusoidal signal sources of the receiver 30-1 are replaced with reverse spreading code generator 72-12. The other components of the fourth embodiment are the same as those shown in FIG. 3 and thus will be omitted from the explanation by assigning common symbols.

The spreading code generators 52-11 of the transmitters 10-1 output different sequences of spreading codes from each other. Each of these spreading code sequences is multiplied with the baseband signal to spectrum spread the baseband signal. The fourth embodiment utilizes the resultant spectrum spread signals as replica signals.

The receiver 30-1 performs the reverse spectrum spreading process on replica signals getting in from the transmission line 20-2 by multiplying the reverse spreading code sequence, which has been output by the reverse spreading code generator 72-12, and the receive signal together.

The operation of the fourth embodiment will now be described in detail by referring to the drawings.

Remember that the first embodiment adjusts the frequency spectrums of replica signals from the transmitters so that they do not overlap with each other. In other words, it uses the frequency-division multiplex technique to superpose replica signals onto outside the baseband. The fourth embodiment, in contrast, uses the code-division multiplex technique to realize the independence among replica signals, rather than the frequency-division multiplex technique. More specifically, this embodiment makes the code sequences S1, S2 vary among the spreading code generators, instead of changing the oscillatory frequency from one sinusoidal signal source to another. The code sequences used for the purpose of this embodiment are those that maintain an orthogonal relationship with each other, such as PN and Gold sequences.

Since the bit rate of a spreading code is several to several tens times the bit rate of a base band signal, the frequency spectrum of an output signal from each of the multipliers 12-12, 12-22 spreads across a very wide band. FIGS. 2(a) and (b) show the frequency spectrums of signals 314a, 324a that are output from the transmitters 10-1, 10-2.

At the receiver 30-1, the reverse spectrum spreading process is performed to detect replica signals getting in as ANEXT signals. The reverse spread code sequence output from the reverse spread code generator 72-12 is S2, which is the same as the spread code from the transmitter 10-2, which is the ANEXT signal source. To extract replica signals, reverse spectrum spreading is conducted on the replica signals getting in the receiver by multiplying each of the reverse spreading code sequences and the receive signal 331a together. The operation after extracting the replica signals is the same as FIG. 3 and therefore will be omitted from the explanation.

### Fifth Embodiment

While the fourth embodiment has been described to explain situations where there is only one source of ANEXT signals, the fifth embodiment will now be described to show how the present invention addresses cases where more than one ANEXT signal source is present.

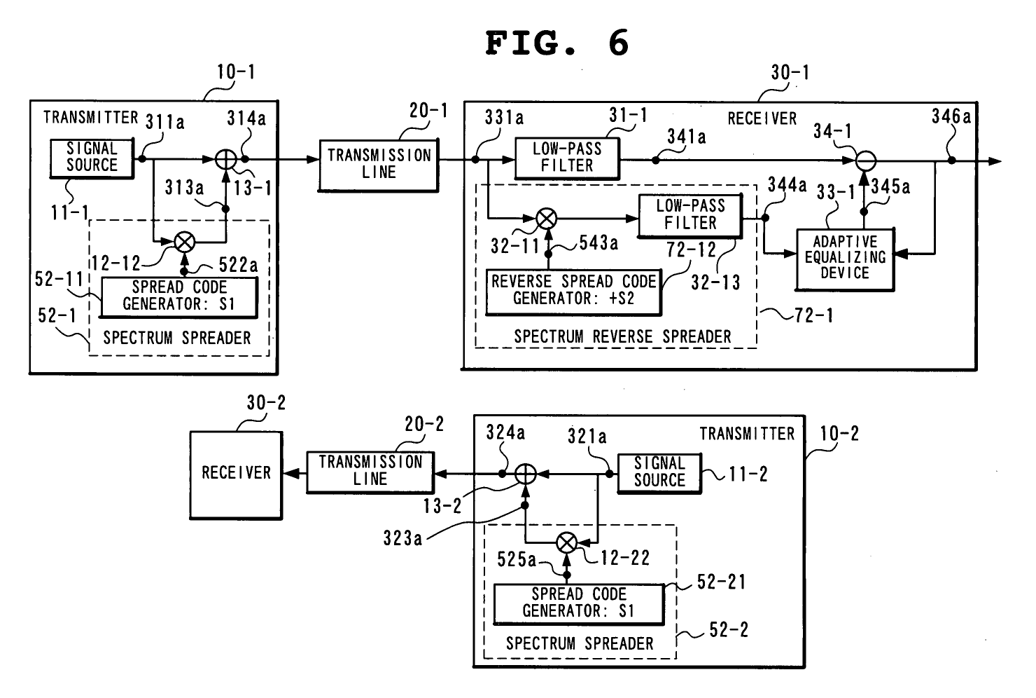

With reference to FIG. 7, the fifth embodiment of the present invention is different from the second embodiment shown in FIG. 4 in that the transmitters 10-1 to 10-n of the former have spreading code generators, rather than the sinusoidal signal sources as in the second embodiment. The fifth embodiment is also different from the second embodiment shown in FIG. 4 that the sinusoidal signal sources of the receiver are replaced with the reverse spreading code generators. The other components of the fifth embodiment are the same as those shown in FIG. 4 and thus will be omitted from the explanation by assigning common symbols.

The spreading code generators 52-11 to 52-n1 of the spectrum spreaders 52-1 to 52-n of the transmitters 10-1 to 10n output different spreading code sequences from one another. Each of these spreading code sequences is multiplied with the baseband signal to spectrum spread the baseband signal. The fifth embodiment utilizes the resultant spectrum spread signals as replica signals.

The receiver 30-1 performs the reverse spectrum spreading process on replica signals getting in from the transmission lines 20-2 to 20-n by multiplying each of the reverse spreading code sequences that have been output by the reverse spreading code generators 72-121 to 72-12m with the receive signal.

The operation of the fifth embodiment of the present invention will now be described in detail with reference to the drawings.

The first embodiment uses the frequency-division multiplex technique to superpose replica signals onto outside the baseband. However, the fifth embodiment employs the code-division multiplex technique to realize the independence among replica signals, rather than the frequency-division multiplex technique.

More specifically, this embodiment makes the code sequences S1, S2, S3, . . . Sn vary among the spreading code generators 52-11 to 52-n1, instead of changing the oscillatory frequency from one sinusoidal signal source to another. The code sequences used for the purpose of this embodiment are those that maintain an orthogonal relationship with each other, such as PN and Gold sequences.

Since the bit rate of a spreading code is several to several tens times the bit rate of a base band signal, the frequency spectrum of an output signal from each of the multipliers 12-12, 12-22, 12-32, 12-n2 spreads across a very wide band. The frequency spectrums of signals 314a and 324a that are output from the transmitters 10-1, 10-2 are as shown in FIGS. 2(a) and (b).

At the receiver 30-1, the reverse spectrum spreading process is performed to detect replica signals getting in as ANEXT signals. Reverse spreading codes output from the reverse spreading code generators 72-121 to 72-12m of the spectrum reverse spreaders 72-1 to 72-m are indicated by symbols S2, S3, . . . , Sn, which are the same as spreading codes for interfering transmitters.

To extract replica signals, the reverse spectrum spreading process is conducted on the replica signal getting in the receiver by using the multiplier 32-111 to 32-11m to multiply each of the reverse spreading code sequences and the receive signal 331a together. The operation after extracting the replica signals is the same as FIG. 4 and therefore will be omitted from the explanation.

### Sixth Embodiment

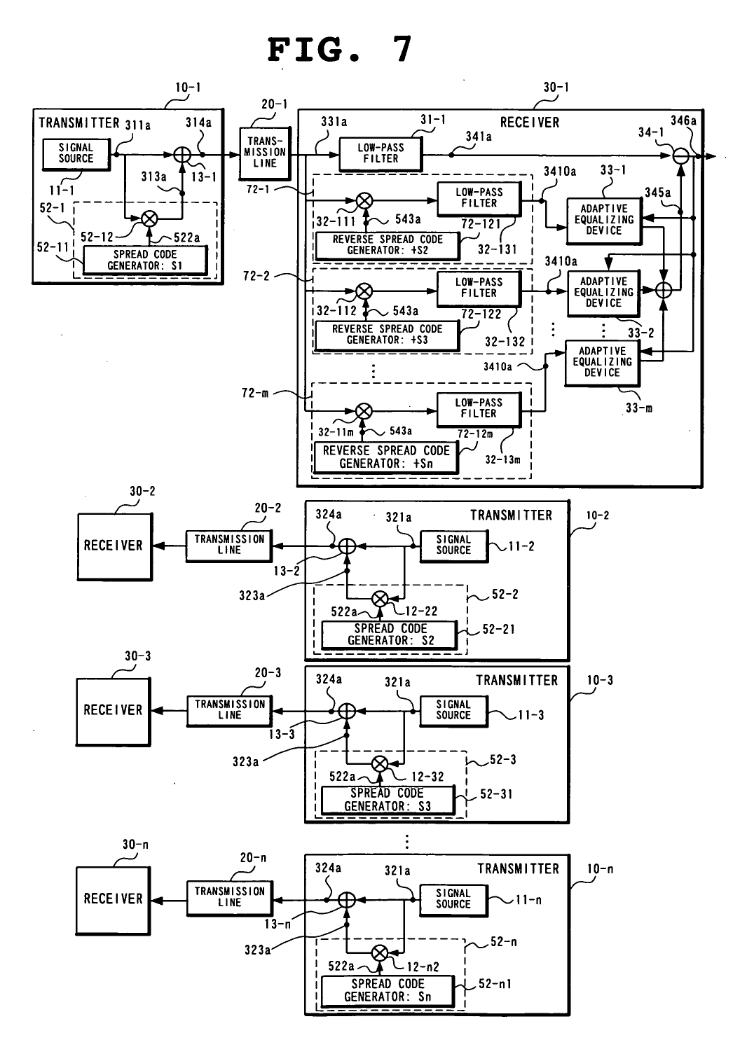

FIG. 8 shows the sixth embodiment, which is an extended configuration based on the fifth embodiment, as is the case with the third embodiment.

By using this configuration of the sixth embodiment, the system can detect spreading code sequences of replica signals getting into its receiver, even when it is placed in a completely new communication environment as a result of rearrangement of existing communication devices or introduction of one or more new communication devices.

The sixth embodiment is an improvement over the fifth embodiment. The configuration of the sixth embodiments is different from the one shown in FIG. 7 in that code sequences generated by each of the spreading code generators 52-11 of the code spreader 52-1 are adjustable. It is also different from the configuration of FIG. 7 in that the system includes a code assigning device 75-1 which sets up optimally a code sequence from the spreading code generator 52-11 of the transmitter 10-1 and code sequences from the reverse spreading code generators 72-121 to 72-12m of the receiver 30-1. The other components of this configuration are the same as FIG. 7 and therefore will be omitted from the explanation.

The following explanation assumes that new communication devices, i.e., a transmitter 10-1 and a receiver 30-1, are introduced into a communication environment that already contains transmitters 10-2 to 10-n and receivers 30-2 to 30-n. Using this environment, the operation of the system to set up the spreading code sequence of replica signals in the new transmitter 10-1 and the new receiver 30-1 will now be described.

In the training mode for initialization, the code assigning device 75-1 first sets the output signal from the spreading code generator 52-11 to “0,” and then measures the strength of the output signal from the low-pass filter 32-131 while changing the code sequence of the reverse spreading code generator 72-121. Since the code sequence measured when the strength of this output signal reaches the maximum value corresponds to Code Sequence S2 of the spreading code generator 52-21 of the transmitter 10-2, which is the ANEXT signal source, the system assigns these code sequences to the reverse spreading code generator 72-121.

By repeating the similar setup process, the system varies the respective code sequences of the reverse spreading code generators 72-122 to 72-12m to measure and identify the respective code sequences at which the strength of the output signal that passes the low-pass filter 32-132 to 32-13m reaches the maximum value, and assigns these code sequences corresponding to the Code Sequences S3, . . . Sn of the spreading code generators 52-31 to 52-n1 of the transmitters 10-3 to 10n, which are the ANEXT signal sources, to the reverse spreading code generators 72-122 to 72-12m.

At the same time, to the spreading code generator 52-11, the system assigns the code sequences that are different from those of the reverse spreading code generators 72-121 to 72-12m, so that code interference will not occur between replica signals.

In the sixth embodiment, the system can detect replica signals getting in the receiver under any possible circumstances by employing the code-division multiplex technique to realize the independence among replica signals when superposing these replica signals onto the baseband signals, as well as by making it possible to adjust code sequences of the spreading code generators and the reverse spreading code generators. By this, this embodiment can extract the original information of the ANEXT component from the replica signals, and use the information to suppress the ANEXT component that has crossed into the bandwidth, even if the system is installed in a completely new communication environment.

### Seventh Embodiment

When superposing replica signals onto baseband signals as in the fourth embodiment, the present invention can prevent the signal-to-noise ratio (SNR) of the baseband signals from being deteriorated due to the replica signals that have crossed into the baseband, by configuring the system to up-convert the replica signals to outside the baseband. Such configuration is shown in FIG. 9 as the seventh embodiment.

The configuration of FIG. 9 is different from that of FIG. 6 in that the transmitter 10-1 in the former includes a sinusoidal signal source 12-11 for up-conversion and that the receiver 30-1 includes a sinusoidal signal source 32-11 for down-conversion. The other components of this configuration are the same as FIG. 6 and therefore will be omitted from the explanation.

As indicated by the waveform in FIG. 9, replica signals transmitted from the transmitter 10-1 do not cause the SNR of baseband signals to be deteriorated because, in addition to being spectrum spread, they are up-converted using Carrier Frequency C by the sinusoidal signal source 12-11. Moreover, similarly to the first embodiment, the seventh embodiment up-converts replica signals to the high-frequency area and thus can utilize the high-pass characteristics of ANEXT, thereby improving accuracy in detecting the replica signals.

### Eighth Embodiment

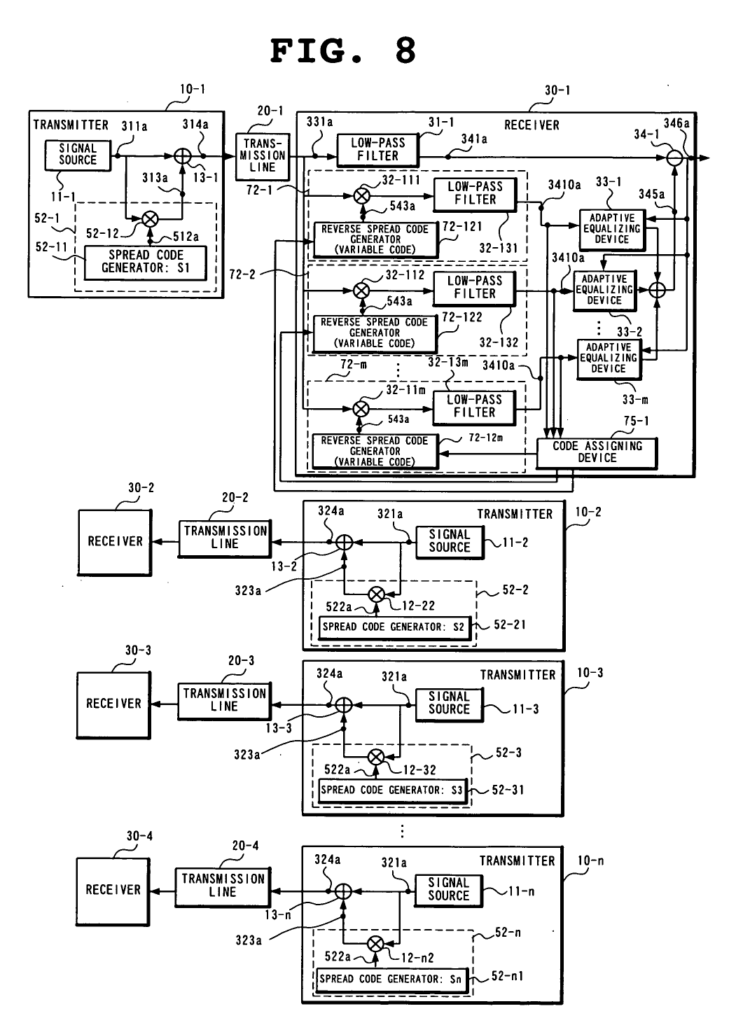

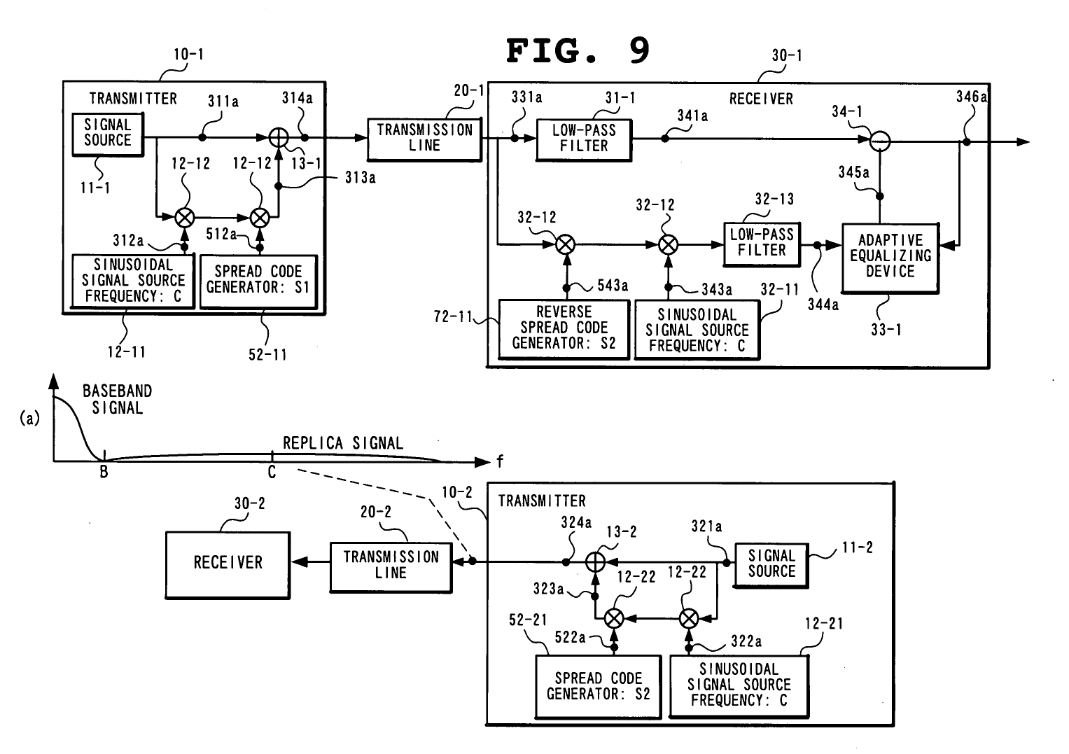

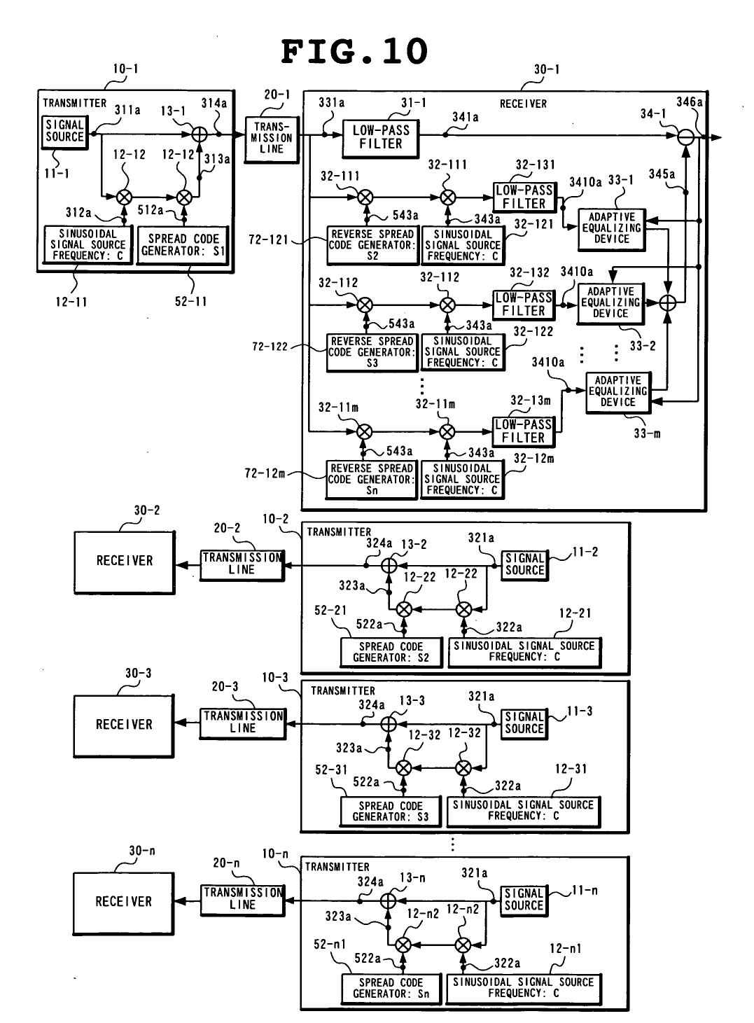

FIG. 10 shows the configuration of the eighth embodiment, wherein the seventh embodiment is modified to address cases where more than one transmitters and receivers are present. In the eighth embodiment as well, when superposing replica signals onto baseband signals, the present invention can prevent the SNR of the baseband signals from being deteriorated due to the replica signals that have crossed into the baseband by configuring the system to up-convert the replica signals to outside the baseband.

In the eighth embodiment shown in FIG. 10, each of the transmitter 10-1 to 10-n includes a sinusoidal signal source 12-11 to 12-n1 for up-conversion, and each of the receivers 30-1 to 30-n includes multiple sinusoidal signal sources 32-121 to 32-12m for down-conversion. The other components of this configuration are the same as FIG. 7 and therefore will be omitted from the explanation.

Similarly to the sixth embodiment, in the eighth embodiment, replica signals transmitted from the transmitter do not cause the SNR of baseband signals to be deteriorated because, in addition to being spectrum spread, they are up-converted using Carrier Frequency C. Moreover, similarly to the first embodiment, the eighth embodiment up-converts replica signals to the high-frequency area and thus can utilize the high-pass characteristics of ANEXT, thereby improving accuracy in detecting the replica signals.

As is clear from the foregoing, the transmitting/receiving system according to the present invention can provide the effect of suppressing ANEXT efficiently without needing to be wire-connected with nearby transmitters, which are the source of ANEXT signals that have crossed into its receive signals.

This is possible because the system can restore quasi-ANEXT signals from replica signals getting into its receiver and thus is capable of performing the crosstalk suppressing process based on quasi-crosstalk signals as effectively as conventional NEXT suppressing devices.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A transmitting/receiving system which transmits signals using two or more transmission lines, wherein:
a transmitter and a receiver on one transmission line suppresses crosstalk in a receive baseband signal by detecting, through use of the high-pass characteristics of crosstalk signals, a crosstalk signal which has been sent out by another transmitter as a source of crosstalk on another transmission line, and which has been superposed onto the baseband signal.

2. A transmitting/receiving system which transmits signals using two or more transmission lines, wherein:
a transmitter on each of the transmission lines
comprises a transmitting part which transmits baseband signals after superposing a replica signal of each of said baseband signals for transmission onto said baseband signal; and
a receiver on said transmission line
comprises a filter which extracts the component of said baseband signal received that is inside the baseband,
an extracting part which extracts each of said replica signals that causes a crosstalk by crossing in from said baseband signal received,
an equalizing part which generates a quasi-crosstalk by equalizing each of said replica signals extracted, and
a subtracter which subtracts said quasi-crosstalk signal from the signal inside said baseband.

3. The transmitting/receiving system as set forth in claim 2, wherein
said receiver includes as many said extracting parts and as many said equalizing parts as the number of transmitters on other transmission line, and
multiple said extracting parts extract multiple said replica signals which have crossed in from other transmission line.

4. The transmitting/receiving system as set forth in claim 2, wherein
said equalizing part is an adaptive equalizer which is optimized so that the crosstalk component contained in an output signal from said subtracter will be minimized.

5. The transmitting/receiving system as set forth in claim 2, wherein
said receiver includes as many said extracting parts and as many said equalizing parts as the number of transmitters on other transmission line,
multiple said extracting parts extract individually multiple said replica signals which have crossed in from other transmission line, and
said equalizing part is an adaptive equalizer which is optimized so that the crosstalk component contained in an output signal from said subtracter will be minimized.

6. The transmitting/receiving system as set forth in claim 2, wherein
said replica signal is generated by performing single-sideband frequency modulation or vestigial side-band modulation on said baseband signal.

7. The transmitting/receiving system as set forth in claim 2, wherein
said each replica signal is superposed by multiplexing the replica signal by frequency division into a different frequency area by use of a carrier wave with a frequency over two times wider than the baseband bandwidth.

8. The transmitting/receiving system as set forth in claim 2, wherein
said transmitting part of said transmitter includes an up-converter which multiplexes said replica signal by frequency division into the baseband signal, and
said extracting part of said receiver includes a down-converter which separates said replica signal from the baseband signal.

9. The transmitting/receiving system as set forth in claim 2, wherein
said transmitting part of said transmitter includes an up-converter which multiplexes said replica signal by frequency division into the baseband signal,
said extracting part of said receiver includes a down-converter which separates said replica signal from the baseband signal, and
carrier frequencies of said up-converter which multiplexes said each replica signal by frequency division and of said down-converter which separates said replica signal from the baseband signal are adjustable.

10. The transmitting/receiving system as set forth in claim 2, wherein
said transmitting part of said transmitter includes an up-converter which multiplexes said replica signal by frequency division into the baseband signal,
said extracting part of said receiver includes a down-converter which separates said replica signal from the baseband signal,
carrier frequencies of said up-converter which multiplexes said each replica signal by frequency division and of said down-converter which separates said replica signal from the baseband signal are adjustable, and
output signal strength at the output of said down-converter is first measured while sweeping the carrier frequencies of said down-converter, and then said down-converter is assigned a carrier frequency at which the signal strength reaches the maximum and said up-converter is assigned a carrier frequency which will not interfere with such carrier frequency.

11. The transmitting/receiving system as set forth in claim 2, wherein
said each replica signal is superposed through code-division multiplexing by use of spectrum spreading code sequences which are in an orthogonal relationship with each other.

12. The transmitting/receiving system as set forth in claim 2, wherein
said replica signal is spread from said baseband signal across the spectrum and superposed onto the baseband signal in such a manner that the frequency spectrums of the replica signal and the baseband signal will not overlap with each other.

13. The transmitting/receiving system as set forth in claim 2, wherein
said transmitting part of said transmitter includes a spectrum spreader which spreads said baseband signal across the spectrum and which superposes the resultant signal onto the baseband signal in such a manner that the frequency spectrums of the replica signal and the baseband signal will not overlap with each other, and
said extracting part of said receiver includes a spectrum reverse spreader which restores the superposed replica signal component.

14. The transmitting/receiving system as set forth in claim 2, wherein
code sequences of said spectrum spreader and of said spectrum reverse spreader are adjustable.

15. The transmitting/receiving system as set forth in claim 2, wherein
code sequences of said spectrum spreader and of said spectrum reverse spreader are adjustable, and
output signal strength at the output of said spectrum reverse spreader is first measured while varying code sequences of said spectrum reverse spreader, and then said spectrum reverse spreader is assigned a code sequence at which the signal strength reaches the maximum and said spectrum spreader is assigned a code sequence which is in an orthogonal relationship with the code sequence assigned to said spectrum reverse spreader.

16. A receiver on a transmitting/receiving system which transmits signals using two or more transmission lines, comprising:
receiving from the transmitter of each transmission line a signal created by superposing a replica signal onto the baseband signal, and
including a filter which extracts the component of said baseband signal received that is inside the baseband,
an extracting part which extracts each of said replica signals that causes a crosstalk by crossing in from said baseband signal received,
an equalizing part which generates a quasi-crosstalk by equalizing each of said replica signals extracted, and
a subtracter which subtracts said quasi-crosstalk signal from the signal inside said baseband.

17. The receiver as set forth in claim 16, wherein
as many said extracting parts and as many said equalizing parts as the number of transmitters on other transmission line are included, and
multiple said extracting parts extract individually multiple said replica signals which have crossed in from other transmission line.

18. The receiver as set forth in claim 16, wherein
said equalizing part is an adaptive equalizer which is optimized so that the crosstalk component contained in an output signal from said subtracter will be minimized.

19. The receiver as set forth in claim 16, wherein
said each replica signal is superposed by multiplexing the replica signal by frequency division into a different frequency area by use of a carrier wave with a frequency over two times wider than the baseband bandwidth.

20. The receiver as set forth in claim 16, wherein
said extracting part of said receiver includes a down-converter which separates said replica signal from the baseband signal, with respect to the signal which has been transmitted after being multiplexed into the baseband signal by frequency division through use of the up-converter of said transmitter.

21. The receiver as set forth in claim 16, wherein
said extracting part of said receiver includes a down-converter which separates said replica signal from the baseband signal, with respect to the signal which has been transmitted after being multiplexed into the baseband signal by frequency division through use of the up-converter of said transmitter, and
carrier frequency of said down-converter which separates said replica signal from the baseband signal is adjustable.

22. The receiver as set forth in claim 16, wherein
said extracting part of said receiver includes a down-converter which separates said replica signal from the baseband signal, with respect to the signal which has been transmitted after being multiplexed into the baseband signal by frequency division through use of the up-converter of said transmitter,
carrier frequency of said down-converter which separates said replica signal from the baseband signal is adjustable, and
output signal strength at the output of said down-converter is first measured while sweeping the carrier frequencies of said down-converter, and then said down-converter is assigned a carrier frequency at which the output signal strength reaches the maximum and said up-converter is assigned a carrier frequency which will not interfere with such carrier frequency.

23. The receiver as set forth in claim 16, wherein
said each replica signal is superposed through code-division multiplexing by use of spectrum spreading code sequences which are in an orthogonal relationship with each other.

24. The receiver as set forth in claim 16, wherein
said each replica signal is superposed through code-division multiplexing by use of spectrum spreading code sequences which are in an orthogonal relationship with each other, and
said extracting part of said receiver includes a spectrum reverse spreader which restores the superposed replica signal component from the signal created by spreading said baseband signal across the spectrum by use of the spectrum spreader of said transmitter and then superposing the resultant signal so that the frequency spectrum of the resultant signal will not overlap with the frequency spectrum of the baseband signal.

25. The receiver as set forth in claim 16, wherein
code sequences of said spectrum spreader and of said spectrum reverse spreader are adjustable.

26. The receiver as set forth in claim 16, wherein
code sequences of said spectrum spreader and of said spectrum reverse spreader are adjustable, and
output signal strength at the output of said spectrum reverse spreader is first measured while varying code sequences of said spectrum reverse spreader, and then said spectrum reverse spreader is assigned a code sequence at which the signal strength reaches the maximum and said spectrum spreader is assigned a code sequence which is in an orthogonal relationship with the code sequence assigned to said spectrum reverse spreader.

27. A transmitter on a transmitting/receiving system which transmits signals using two or more transmission lines, comprising:
a transmitting part which transmits baseband signals after superposing a replica signal of each of said baseband signals for transmission onto said baseband signal.

28. The transmitter as set forth in claim 27, wherein
said replica signal is generated by performing single-sideband frequency modulation or vestigial side-band modulation on said baseband signal.

29. The transmitter as set forth in claim 27, wherein
said each replica signal is superposed by multiplexing the replica signal by frequency division into a different frequency area by use of a carrier wave with a frequency over two times wider than the baseband bandwidth.

30. The transmitter as set forth in claim 27, wherein
said transmitting part of said transmitter includes an up-converter which multiplexes said replica signal by frequency division into the baseband signal, and
said replica signal is separated from the baseband signal by the down-converter of said receiver.

31. The transmitter as set forth in claim 27, wherein
said transmitting part of said transmitter includes an up-converter which multiplexes said replica signal by frequency division into the baseband signal,
said replica signal is separated from the baseband signal by the down-converter of said receiver, and
said carrier frequency of said up-converter which multiplexes said each replica signal by frequency division is adjustable along with the carrier frequency of said down-converter of the receiver which separates said replica signal from the baseband signal.

32. The transmitter as set forth in claim 27, wherein
said transmitting part of said transmitter includes an up-converter which multiplexes said replica signal by frequency division into the baseband signal,
said replica signal is separated from the baseband signal by the down-converter of said receiver,
said carrier frequency of said up-converter which multiplexes said each replica signal by frequency division is adjustable along with the carrier frequency of said down-converter of the receiver which separates said replica signal from the baseband signal, and
said up-converter is assigned a carrier frequency which will not interfere with the carrier frequency assigned to said down-converter.

33. The transmitter as set forth in claim 27, wherein
said each replica signal is superposed through code-division multiplexing by use of spectrum spreading code sequences which are in an orthogonal relationship with each other.

34. The transmitter as set forth in claim 27, wherein
said replica signal is spread from said baseband signal across the spectrum and superposed onto the baseband signal in such a manner that the frequency spectrums of the replica signal and the baseband signal will not overlap with each other.

35. The transmitter as set forth in claim 27, wherein
said each replica signal is superposed through code-division multiplexing by use of spectrum spreading code sequences which are in an orthogonal relationship with each other, and
said transmitting part of said transmitter includes a spectrum spreader which spreads said baseband signal across the spectrum and which superposes the resultant signal onto the baseband signal in such a manner that the frequency spectrums of the replica signal and the baseband signal will not overlap with each other.

36. The transmitter as set forth in claim 27, wherein
said each replica signal is superposed through code-division multiplexing by use of spectrum spreading code sequences which are in an orthogonal relationship with each other, and
code sequence of a spectrum spreader is adjustable along with the code sequence of a spectrum reverse spreader of a receiver.

37. The transmitter as set forth in claim 27, wherein
said each replica signal is superposed through code-division multiplexing by use of spectrum spreading code sequences which are in an orthogonal relationship with each other,
code sequence of a spectrum spreader is adjustable along with the code sequence of a spectrum reverse spreader of a receiver, and
output signal strength at the output of said spectrum reverse spreader is first measured while varying code sequences of said spectrum reverse spreader, and then said spectrum reverse spreader is assigned a code sequence at which the output signal strength reaches the maximum and said spectrum spreader is assigned a code sequence which is in an orthogonal relationship with the code sequence assigned to said spectrum reverse spreader.
